(19) United States
(12) Patent Application Publication
(10) Pub. No.: US 2004/0013265 A1
(43) Pub. Date: Jan. 22, 2004

(54) Cellular phone holding device

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314

(21) Appl. No.: 10/196,243

(22) Filed: Jul. 17, 2002

(51) Int. Cl. H04M 1/00

(52) U.S. Cl. 379/441

(57) ABSTRACT

The present invention is to provide a cellular phone holding device comprising a loop assembly for permitting an object (e.g., belt) to pass through a loop integrally formed by a left and a right clips, the loop assembly including a projected lower latched piece; and a pivotal assembly pivotably coupled to the loop assembly so that the pivotal assembly is capable of pivoting about the loop assembly to form an angle sufficiently enough to permit a user to see the number of an incoming call shown on a display of a cellular phone held thereon.

### FIELD OF THE INVENTION

The present invention relates to cellular phone accessories and more particularly to a pivotal holding device having one side for receiving a cellular phone so that the user can pivot the device to see the number of an incoming call without having to remove the cellular phone from the device.

### BACKGROUND OF THE INVENTION

Recently, cellular phones have become very popular around the world. This is particularly true in developed countries such as Taiwan. It is estimated that the number of cellular phone users is about five millions at the end of year 2000. Further, such number is still increasing. The advantages of cellular phone is compact, portable, and convenient. However, it has drawbacks of being lost and susceptible of being damaged if enough care is not taken (e.g., dropped on the ground). Conventionally, a cellular phone is placed in an enclosure which in turn is placed in a pocket. However, such may cause inconvenience in removing the cellular phone when a use is desired.

Another conventional arrangement is to form a clip on the rear of cellular phone. The clip is fastened to a belt of the user. As such, the user can conveniently remove the cellular phone from the belt for communication purpose. A similar cellular phone holder is shown in FIG. 1 and comprises a housing 1 having a slot on an outer surface and a detent 10 within the housing 1 opposite to the slot. At the same side as the detent 10, there are further provided a slide piece 12 having a top end projected from the top of the housing 1 and a bottom end in contact with the detent 10; an elastic member (e.g., spring) 18 biased between the slide piece 12 and the housing 1, the slide piece 12 capable of being pressed down to cause a pin of the detent 10 to project from the housing 1 or being released to return to its original position by an expansion of the spring 18; a flexible member 14 having one end secured to the housing 1; and an engagement member 16 secured to to the other end of the flexible member 14 (i.e., adjacent the detent 10). As such, the holder can be attached to a foreign object. For example, pass a belt through the holder and around the waist of user. Moreover, there is provided a fastening member 2 on an enclosure of the cellular phone or the cellular phone directly. The fastening member 2 is adapted to slide to receive in the slot. Further, the fastening member 2 is locked by the detent 10 after in place.

However, at this arrangement the user cannot see a display of the cellular phone since typically the display faces opposite to the belt. As such, the user cannot see the number of an incoming call, messages, or the like shown on the display when such occurs. In response, the user has to press the slide piece 12 to unlock the fastening member 2 in the slot. Then the user can remove the cellular phone for viewing the display. Alternatively, the user can pivot the cellular phone directly for viewing. In view of the above, it is quite inconvenient. Further, such pivoting of the cellular phone tends to damage the holder and/or the belt. Thus improvement exists.

### SUMMARY OF THE INVENTION

It is therefore an object of the present invention to provide a cellular phone holding device comprising a loop assembly for permitting an object (e.g., belt) to pass through a loop formed by the left and the right clips, the loop assembly including a projected lower latched piece; and a pivotal assembly pivotably coupled to the loop assembly so that the pivotal assembly is capable of pivoting either clockwise about the loop assembly to form an angle therebetween or counterclockwise about the loop assembly to be substantially parallel to and in close proximity with the loop assembly, the pivotal assembly including a lower opening for receiving the latched piece and securing thereto as the pivotal assembly is disposed in close proximity with the loop assembly, thereby securing the pivotal assembly to the loop assembly. In response to the device held on the belt and the cellular phone is held by the device, the pivotal assembly is capable of swinging clockwise relative to the loop assembly at an angle sufficiently enough to permit a user to see the number of an incoming call shown on a display of the cellular phone.

In one aspect of the present invention, the loop assembly consists of a left clip and a right clip integral with the left clip at its top so that the invention can have advantages of being small in the number of components, simple construction, easy to manufacture, and lower in the manufacturing cost.

In another aspect of the present invention, the pivotal assembly further comprises a longitudinal slot for fastening the cellular phone and a fastening member at a lower part of the longitudinal slot so that a mated fastening member on the cellular phone is adapted to slide downward to receive in and secure to the longitudinal slot.

In still another aspect of the present invention, the fastening member comprises two side openings near the lower opening at a bottom of the pivotal assembly, a flexible member extended downward between the side openings being capable of bending, a cam adjacent a lower end of the flexible member, a top slot above the longitudinal slot, and a slide piece slidably received in the longitudinal slot, and a bottom recess with the cam snugly receiving therein so that it is possible of pressing the slide piece to cause the recess to push the cam, the cam being disengaged from the mated fastening member as a result of further pressing of the slide piece, thereby removing the cellular phone from the pivotal assembly.

The above and other objects, features and advantages of the present invention will become apparent from the following detailed description taken with the accompanying drawings.

### BRIEF DESCRIPTION OF THE DRAWINGS

FIG. 1 is an exploded view of a conventional cellular phone holder;

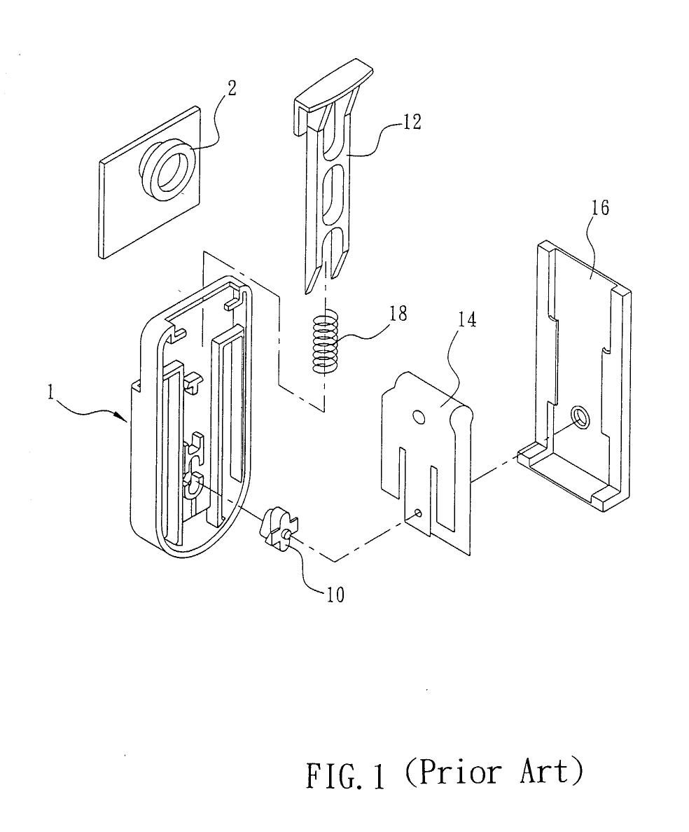

FIG. 2 is an exploded view of a preferred embodiment of a cellular phone holder according to the invention;

FIG. 3 is a perspective view of the assembled holder and a cellular phone adapted to be held by the holder;

FIG. 4 is a cross-sectional view of the holder and the cellular phone secured to the holder when the cellular phone is carried by a user;

FIG. 5 is a view similar to FIG. 4 where the cellular phone is pivoted from the position shown in FIG. 4 to a horizontal position shown in phantom lines; and

FIG. 6 is a view similar to FIG. 4 showing a step of disengaging a cam from a recess.

### DETAILED DESCRIPTION OF THE PREFERRED EMBODIMENTS

The invention is directed to a pivotal cellular phone holder which enables a user to swing the holder to see the number of an incoming call shown on a display, thereby eliminating the drawbacks (i.e., user cannot directly see the display of the cellular phone held on the belt worn by the user) associated with the prior art.

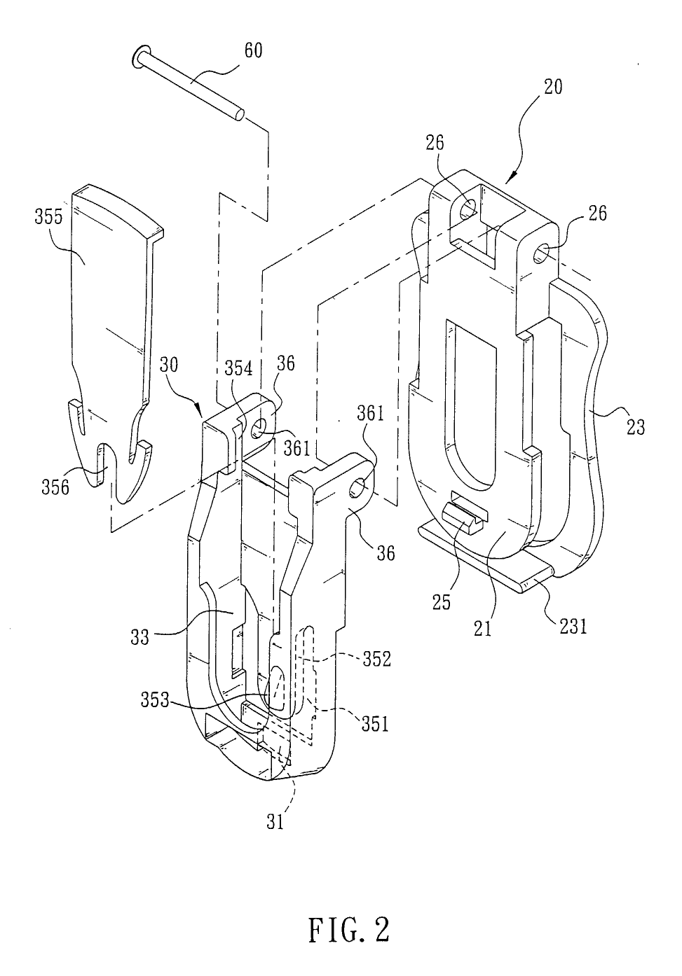

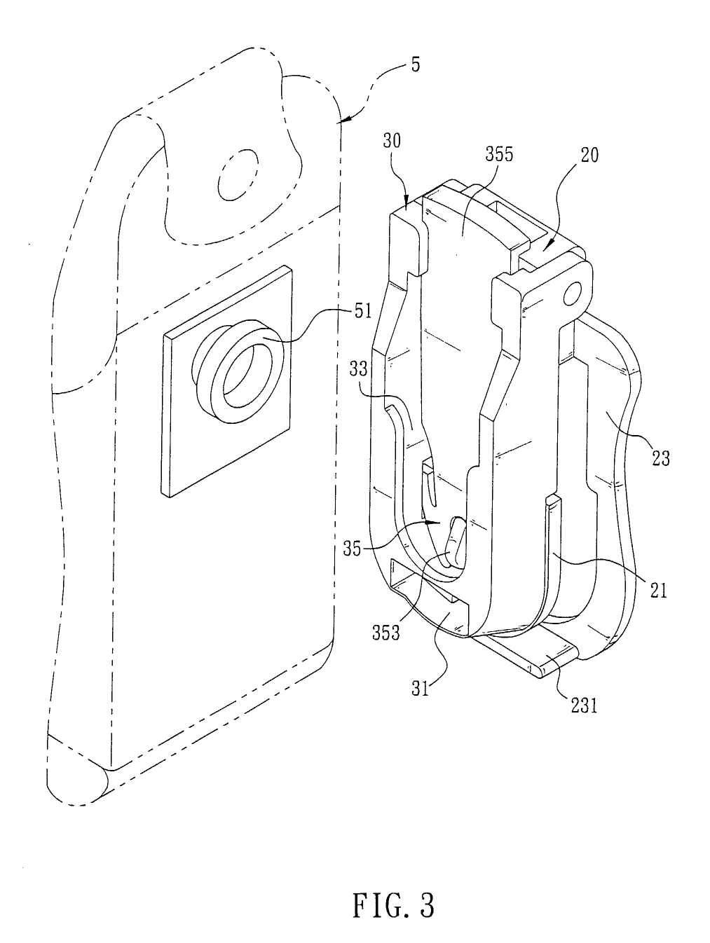

Referring to FIGS. 2 and 3, there is shown a preferred embodiment of a cellular phone holder in accordance with the invention comprising a loop assembly 20 including a left clip 21 and a right clip 23 integral with the left clip 21 at the top. As such, the loop assembly 20 can possess a capability for fastening an object. A horizontal piece 231 is formed on a lower end of the right clip 23 as an auxiliary support while the loop assembly 20 is coupled to an object (e.g., a belt passes through a loop formed by the left and the right clips 21 and 23 and around the waist of a user). A pivotal assembly 30 is pivotably secured to the loop assembly 20. As such, the pivotal assembly 30 can be pivoted clockwise about the loop assembly 20 to form an angle therebetween or counterclockwise about the loop assembly 20 to be substantially parallel to and in close proximity with the loop assembly 20. The pivotal assembly 30 comprises a lower opening 31 adjacent the free end. The loop assembly 20 comprises a lower latched piece 25 projected from the left clip 21 corresponding to the lower opening 31. As such, the user can pivot the pivotal assembly 30 counterclockwise about and in close proximity with the loop assembly 20 until the latched piece 25 is received and secured to the lower opening 31. As an end, the pivotal assembly 30 is secured to the loop assembly 20.

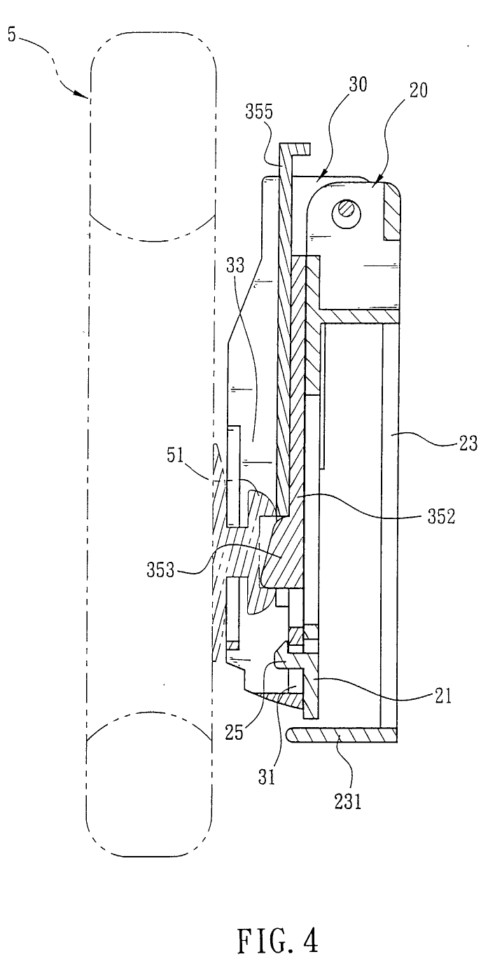

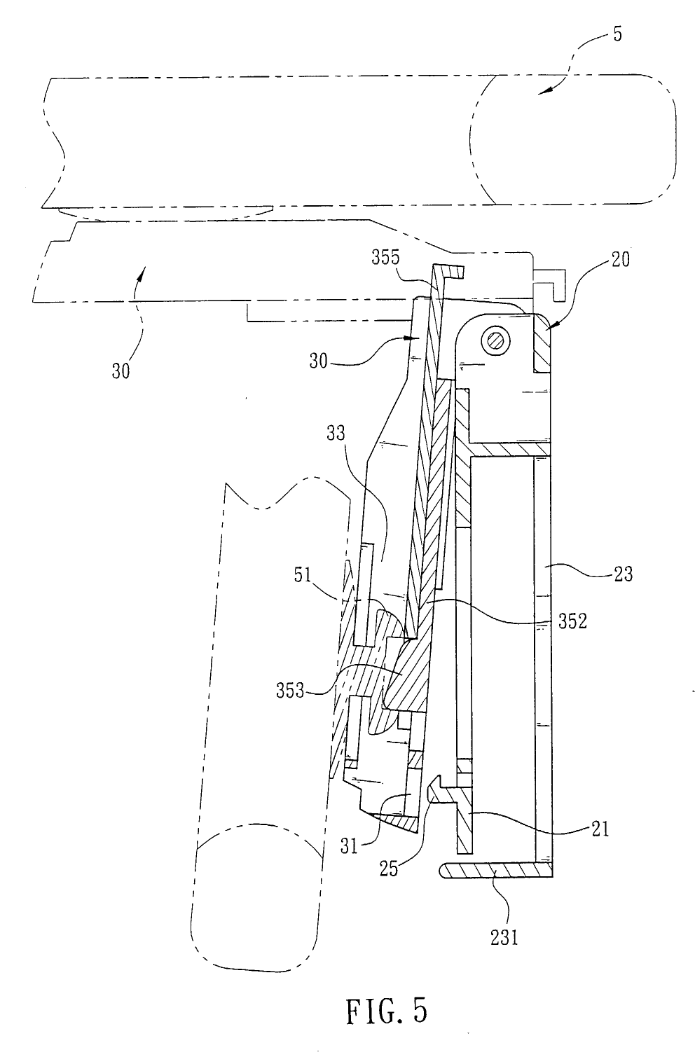

Referring to FIGS. 3 and 4, the pivotal assembly 30 further comprises a longitudinal slot 33 opposite to the loop assembly 20 for fastening a the cellular phone 5, a fastening member 35 at a lower part of the longitudinal slot 33. As such, a mated fastening member 51 on the cellular phone 5 is adapted to slide downward and receive in the longitudinal slot 33. The mated fastening member 51 is thus locked by the fastening member 35 after in place. In a case that the loop assembly 20 is held on the belt worn by the user and the cellular phone 5 is fastened by the pivotal assembly 30, the user can pivot the pivotal assembly 30 clockwise relative to the loop assembly 20 until the number of the incoming call shown on a display of the cellular phone 5 is seen (see FIG. 5).

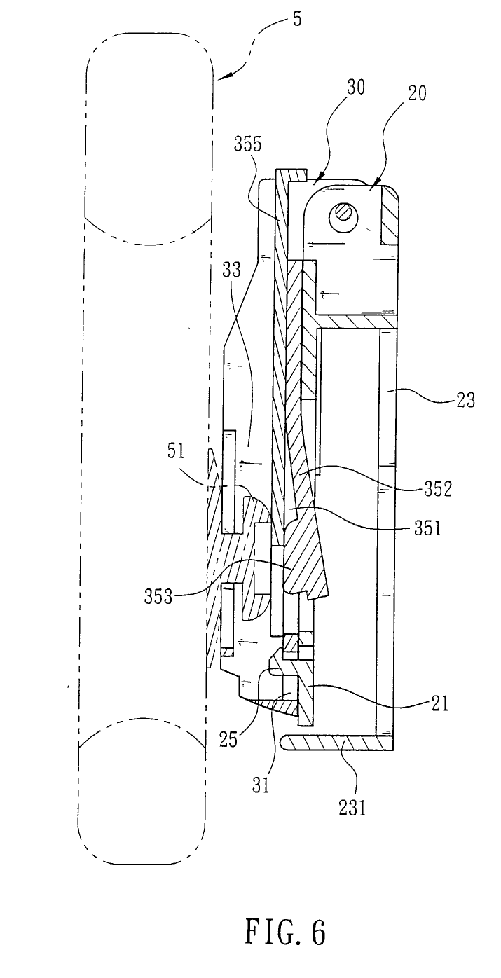

Referring to FIGS. 2, 3 and 6, in the embodiment the fastening member 35 comprises an opening 351 at either side near the lower opening 31 at the bottom of the pivotal assembly 30, a flexible member 352 extended downward between the side openings 351 capable of bending either clockwise or counterclockwise in a small angle, a cam 353 adjacent a lower end of the flexible member 352, a top slot 354 above the longitudinal slot 33, a slide piece 355 slidably received in the top and the longitudinal slot 354, and a bottom recess 356 at the bottom of the slide piece with the cam 353 snugly receiving therein. In mounting the cellular phone 5 onto the pivotal assembly 30, user can slide down the mated fastening member 51 on the cellular phone 5 along the longitudinal slot 33 for securing the mated fastening member 51 to the cam 353 (see FIG. 4). In removing the cellular phone 5 from the pivotal assembly 30 the user can press the slide piece 355 to cause the recess 356 to push the cam 353 for disengaging the cam 353 from the mated fastening member 51 as a result of further pressing of the slide piece 355 (i.e., the flexible member 352 pivoted counterclockwise). At this position, the user can remove the cellular phone 5 from the pivotal assembly 30 (as seen in FIG. 6).

Referring to FIG. 2, in the embodiment the loop assembly further comprises a hole 26 at either side of the joint of the pivotal assembly and the loop assembly. Correspondingly, the pivotal assembly 30 further comprises a horizontal top lug 36 at either side and having a hole 361 at either lug 36. There is further provided a pin 60, of which the diameter almost the same as the diameter of the hole 361, inserted through the holes 361 and 26 to pivotably secure the loop and the pivotal assemblies 20 and 30 together. In the embodiment, since the diameter of the hole 26 is more larger than that of the pin 60, the pin 60 can be moved vertically within the hole 26, while the pivotal assembly 30 being in close proximity with the loop assembly 20, until the latched piece 25 is secured to the lower opening 31 or released from the lower opening 31.

Thus, in a case that an incoming call is received by the cellular phone 5 which is coupled to a belt of the user, the user can perform the following steps of disengaging the latched piece 25 from the lower opening 31 and clockwise pivoting the pivotal assembly 30 relative to the loop assembly 20 until the number of the incoming call shown on the display of the cellular phone 5 is seen. Since the right clip 23 is integrally formed with the left clip 21 at its top, thus the loop assembly 20 can have the advantages of being small in the number of components, simple construction, and easy to manufacture. As a result, the manufacturing cost is lowered significantly.

While the invention has been described by means of specific embodiments, numerous modifications and variations could be made thereto by those skilled in the art without departing from the scope and spirit of the invention set forth in the claims.

What is claimed is:

1. A device for holding a cellular phone comprising:
a loop assembly including a left clip and a right clip integral with the left clip at its top for permitting an object to pass through a loop formed by the left and the right clips and to be gripped;
a pivotal assembly pivotably coupled to the top of the loop assembly so that the pivotal assembly is capable of pivoting either clockwise about the loop assembly to form an angle therebetween or counterclockwise about the loop assembly to be substantially parallel to and in close proximity with the loop assembly, the pivotal assembly including a longitudinal slot for fastening the cellular phone; and
a fastening member at a lower part of the longitudinal slot so that a mated fastening member on the cellular phone is adapted to slide downward to receive in and secure to the longitudinal slot;
whereby in response to the device held on the object and the cellular phone is held by the device, the pivotal assembly is capable of swinging clockwise relative to the loop assembly at an angle sufficiently enough to permit a user to see the number of an incoming call shown on a display of the cellular phone.

2. The device of claim 1, wherein the pivotal assembly further comprises a projected lower latched piece and the pivotal assembly further comprises a lower opening for receiving the latched piece and securing thereto as the pivotal assembly is disposed in close proximity with the loop assembly, thereby securing the pivotal assembly to the loop assembly.

3. The device of claim 2, wherein the fastening member comprises two side openings near the lower opening at a bottom of the pivotal assembly, a flexible member extended downward between the side openings being capable of bending, a cam adjacent a lower end of the flexible member, a top slot above the longitudinal slot, and a slide piece slidably received in the longitudinal slot, and a bottom recess with the cam snugly receiving therein so that it is possible of pressing the slide piece to cause the recess to push the cam, the cam being disengaged from the mated fastening member as a result of further pressing of the slide piece, thereby removing the cellular phone from the pivotal assembly.

4. The device of claim 1, wherein the loop assembly further comprises a hole at either top side and the pivotal assembly further comprises a horizontal top lug at either side and an aperture at either lug, and further comprising a pin inserted through the apertures and the holes to pivotably secure the loop and the pivotal assemblies together.

5. The device of claim 1, wherein the right clip comprises a horizontal piece formed on a lower end as an additional support while the loop assembly is coupled to the object.

6. The device of claim 4, wherein the diameter of the holes is larger than that of the pin enabling the pin to be moved vertically within the holes, while the pivotal assembly being in close proximity with the loop assembly, until the latched piece is secured to the lower opening or released from the lower opening.
